(19) United States
(12) Patent Application Publication
(10) Pub. No.: US 2004/0240981 A1
(43) Pub. Date: Dec. 2, 2004

(54) Robot stacking system for flat glass

(75) Inventors: Erez Dothan, Ramat Chen (IL); Benny Naor, Ramat Hasharon (IL); Effi Rubinshtein, Ra'anana (IL)

Correspondence Address: WELSH & KATZ, LTD, 120 S RIVERSIDE PLAZA, 22ND FLOOR, CHICAGO, IL, 60606, US

(73) Assignee: I-Scan Robotics, Kefar Saba (IL)

(21) Appl. No.: 10/448,261

(22) Filed: May 29, 2003

(51) Int. Cl. B65G 61/00

(52) U.S. Cl. 414/795.4

(57) ABSTRACT

A robotic-based system and method for transposing glass sheets of mixed sizes, including jumbo-sized sheets, from or onto a conveyor onto or from unloading platforms positioned on either side of the conveyor. The system comprises two parallel bridges extending across and above the conveyor and a pair of industrial robots movably mounted each on one of said two bridges for allowing traverse movement of the robots along the bridges such that the robots are having equal reach to both sides of the conveyor. The robots may be operated either in a full synchronized mode for handling sheets too large or to heavy to be handled by a single robot or in an individual operation mode where each robot handles a single sheet.

### FIELD OF THE INVENTION

The present invention generally relates to system and method for handling heavy flat objects and in particular to a multi-purpose robotic system for handling and stacking flat glass sheets of mixed sizes directly off or onto a production line.

### BACKGROUND OF THE INVENTION

The float glass process is the dominant industrial process for the production of high-quality glass sheets. In accordance with the float glass process, molten glass is continuously drawn from the furnace to float on a bath of molten tin where it forms a continuous ribbon of about 3 meters width and between 2 to 25 mm thickness. The ribbon exiting the float bath, enters the annealing lehr, where it is cooled uniformly for relieving internal stresses, and is coming out from the lehr on a conveyor system to be cut into plates according to customers' orders. The individual sheets are further carried by the conveyor system along a generally horizontal path to unloading stations where the sheets are unloaded from the conveyor to be stacked in a substantially vertical orientation on glass racks positioned at the sides of the conveyor, ready either directly for transport or for further processing. The whole process from furnace to cold-end, is continuous, fully automatic and computer-controlled.

The present invention relates to the automatic unloading of the individual cut glass sheets at the cold-end of the production line. In particular, the present invention is aimed at handling massive size glass sheets, having the full or half ribbon width cut to different lengths. Sheets of such dimensions are commonly known as jumbo-sized sheets for plates of full ribbon width and about 6 m long, as LES (lehr end size) sheets for plates of full ribbon width and about 2 to 3 m long, and as split size sheets for plates of half ribbon width and 2 to 3 m long. Such plates and in particular the jumbo size plates, may reach a weight of more than 700 Kg. The problem involved is therefore that of lifting the heavy fragile sheets from horizontal position and stacking them in a substantially vertical position on the glass racks. The present invention also relates to the reverse operation, i.e., to the unloading of vertically positioned glass sheets from glass racks onto a substantially horizontal conveyor line, e.g., for further processing. The invention further addresses the handling of mixed size sheets where a combination of jumbo-sized, LES and split size sheets arrive to the unloading stations in a mixed order.

Known flat glass stackers suffer from a number of drawbacks. One main drawback is that known devices are nonflexible dedicated machines that are designed for unloading plates of a particular size and cannot handle mixed size sheets automatically. Another disadvantage is that many of known systems can unload sheets only to one side of the conveyor. Although there exist jumbo stackers, which can unload jumbo plates to both sides of the conveyor, these are expensive machines that operate at a relatively slow rate. Furthermore, known jumbo stackers occupy a large floor space and/or extend to a considerable height above the floor, putting heavy installation space demands. Another drawback of known stackers is their inability to rotate the plates. Thus, most LES stackers machines can place the LES plates only on their narrow side (portrait orientation) while it is desired to have them on their wider side (landscape orientation). Therefore, special separate rotation stations are needed for restacking the plates in the preferred orientation.

Accordingly, it is an object of the present invention to provide a system for receiving and transposing full size glass sheets, in particular jumbo-sized sheets or a combination of jumbo and other sized sheets, which overcomes the drawbacks of the prior art.

In accordance with the above objective, the present invention provides a novel robotic system for unloading full size plates directly off the float line and for stacking the plates onto racks positioned on both sides of the conveyor with no interruption to the production process. The present system can interchangeably handle any combination of LES, split size and jumbo-sized sheets for providing an efficient usage of the system with a minimum requirement for operating personnel and for enhancing speed, flexibility and efficiency. The system configuration reduces the overall space requirements compared to existing stacking system. Furthermore, the present system, being based on available industrial robots, is easy to install and to maintain and can be easily adapted to perform new tasks by appropriate programming.

### SUMMARY OF THE PRESENT INVENTION

The present invention provides an automatic robotic system and method for handling and transposing heavy massive sheets, in particular for massive-size glass sheets including jumbo-sized, LES, split size sheets and a combination thereof. The system allows for interchangeably unloading LES and jumbo size glass directly off the float line and stack them on racks positioned on both sides of the conveyor in a substantially vertical position. The system also allows for the reverse operation, i.e., for unloading sheets from racks onto a conveyor line. The system further allows for repacking, i.e. taking a plate from one rack to another, as well.

The robotic system of the invention comprises two parallel bridges extending at a predetermined height above and across the conveyor perpendicularly to the conveyor longitudinal axis and spaced apart by a predetermined distance defining a conveyor working surface area therebetween; a pair of programmed-controlled articulated industrial robots movably mounted in an upright position each on one of said two bridges for allowing linear movement of the robot along respective bridge; a master computer in communication with the robots controllers, the master computer controls the operation of the pair of robots for allowing a synchronized mode of operation for handling glass sheets to heavy and/or too big to be handled by one robot or an individual operation mode where each robot independently handles a single sheet. When in a synchronized operation mode, one robot is selected as master and the second robot is selected as slave. The system may further comprise a stopping mechanism for stopping and positioning the glass sheets in the conveyor working surface area and a set of sensors for measuring the position of a glass sheet and for sending signals regarding said position to the robot controllers.

Preferably the robots are six-axis heavy payload industrial articulated robots, including a base, an arm, a wrist and a controller for controlling the movements of the robot. A gripping device connected to the wrist allows for gripping the glass sheets. Preferably, the gripping device is a vacuum gripper including a base frame and a plurality of suction cups supported on said base frame, wherein the plurality of suction cups are divided into multiple groups such that each group is controlled separately.

In accordance with one embodiment of the invention the each of the robots is mounted on a driven carriage coupled to a linear guiding rail. The carriage is provided with a driving unit, such as a pinion and racket, for allowing linear translatory movement of the robots each along its respective bridge. The robots may be mounted in an inclined angle, preferably in the range of 5° to 20°, for increasing the reach of the robot toward the conveyor working surface area.

The present invention further provides for a method for unloading glass sheets of mixed sizes off a conveyor onto unloading platforms positioned on either side or both sides of the conveyor the a system comprising at least two bridges extending above and across the conveyor and at least two program-controlled articulated robots movably mounted in an upright position each on one of said at least two bridges, each of the robots is provided with a gripping device. The method comprises the steps of: receiving information regarding dimensions and designated unloading platform of an incoming glass sheets; determining in accordance with said information whether a synchronized operation mode or an independent operation mode is required for handling an incoming glass sheet; and stopping at least one incoming glass sheet between said two bridges. If an independent operation mode is required, the method further comprises the steps of: moving each of the robots independently along respective bridge to lift at least one glass sheet off the conveyor by the gripping device and to place the at least one glass sheet onto designated unloading platform; and releasing the at least one glass sheet from the gripping device. If a synchronized operation mode is required, the method further comprises the steps of: moving the at least two robots each along respective bridge to substantially the center of the bridge; moving the gripping device of each of said at least two robots to be in contact with the glass sheet; synchronously activating the gripping devices to grip the glass sheet; synchronously moving the robots and the gripping devices to lift the glass sheet off the conveyor and to place the glass sheet onto designated unloading platform; and synchronously releasing the glass sheet from the gripping devices. The method may further comprises the step of aligning the glass sheet to a position suitable for unloading. In a synchronized operation mode, one of the two robots is selected to be master robot and the other is selected to be a slave robot.

### BRIEF DESCRIPTION OF THE DRAWINGS

The present invention will be understood and appreciated more fully from the following detailed description taken in conjunction with the drawings in which:

FIG. 1 is a schematic perspective view illustrating a two-robot stacker system in accordance with the present invention showing synchronized operation mode for handling jumbo-sized sheets;

FIG. 2 is an elevational view of FIG. 1 taken from the direction indicated by arrow 2 of FIG. 1;

FIG. 3 is a schematic perspective view illustrating the present system during an individual operation mode for handling LES sheets;

FIG. 4 is a side elevational view of a bridge taken from the direction indicated by arrow 4 of FIG. 1;

FIG. 5 is a partial frontal view taken along lines 5-5 of FIG. 1, showing the robot carriage mover;

FIG. 6 is a top diagrammed overall view of the present system in accordance with one possible configuration;

FIG. 7 are two exemplary screenshots of the monitor panel of the computerized system operative in accordance with the present invention;

FIG. 8 is a schematic block diagram showing the constituent elements of an exemplary robot controller network, in accordance with a preferred embodiment of the present invention;

FIG. 9 is a schematic diagram showing the structure and the constituent elements of an exemplary robot controller, in accordance with a preferred embodiment of the present invention;

FIG. 10 is a simplified flowchart showing the operation of the robot control program in the stand-alone mode, in accordance with a preferred embodiment of the present invention;

FIG. 11 is a simplified flowchart showing the operation of the robot control program running in the master mode, in accordance with a preferred embodiment of the present invention; and

FIG. 12 is a simplified flowchart illustrating the operation of the robot control program running in the slave mode, in accordance with a preferred embodiment of the present invention.

### DETAILED DESCRIPTION OF THE PREFERRED EMBODIMENT

The present invention provides a robotic system with maximum versatility for handling a wide variety of glass plates of mixed sizes and qualities. In particular, the present system can be used for unloading jumbo-sized sheets, LES sheets, split size sheets or a combination thereof directly off the float line and to stack the glass sheets on both sides of the conveyor with no interruption to the production process. The system allows for unloading jumbo size plates onto racks on both sides of the conveyor, for unloading jumbo size on one side of the conveyor and LES or split size plates on the other side, and for unloading different sizes or qualities of LES or split size plates onto four racks, two on each side of the conveyor.

As a combined stacker for jumbo, LES and split size plates the system reduces the required floor space needed for individual separate stackers. Furthermore, the ability to handle a combination mixed size sheets and to stack them on racks positioned on both sides of the conveyor eliminates delays caused when changing racks, thus enhances the efficiency and yield and reduces overhead and operating costs.

The system is based on a pair of synchronized heavy payload industrial robots, preferably 6-axes robots, with an additional translation axis for allowing linear movement of the robots along traverse units installed across the conveyor line. The positioning of the traverse units with respect to the conveyor line and the linear motion of the robots, each along its respective traverse unit, provide the robots with equal access to either side of the conveyor.

The two robots may be operated in a fully synchronized operation mode for handling jumbo-sized glass sheets which are too heavy and/or too big to be handled by a single robot, or in an independent operation mode when handling LES and/or split size sheets. By moving along the traverse units, the robots are capable of simultaneously stacking the glass plates on either side of the conveyor. The location of robots relative to the conveyor reduces the overall space requirements for the system installation.

In the context of the present invention, jumbo-sized sheets generally refer to plates having sizes between 3600×2500 to 6100×3300 mm, LES sheets refer to plates of 1200×2500 to 2500×3300 mm and split size sheets refer to plates of 1200×1200 to 1800×2500 mm. However, it will be easily understood that plates of other dimensions can be handled by the present system, as well.

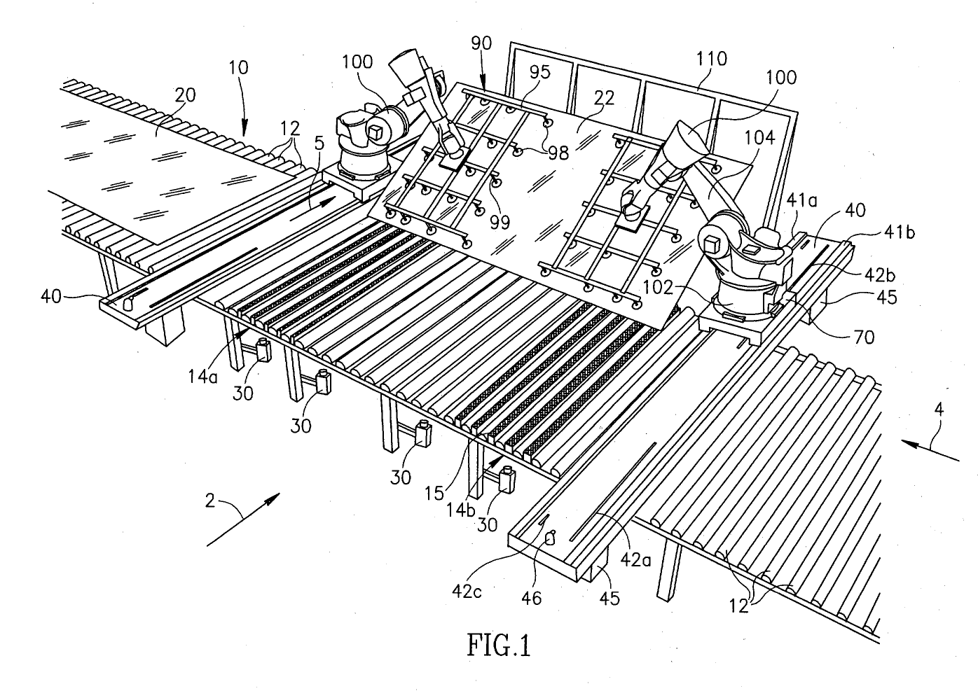

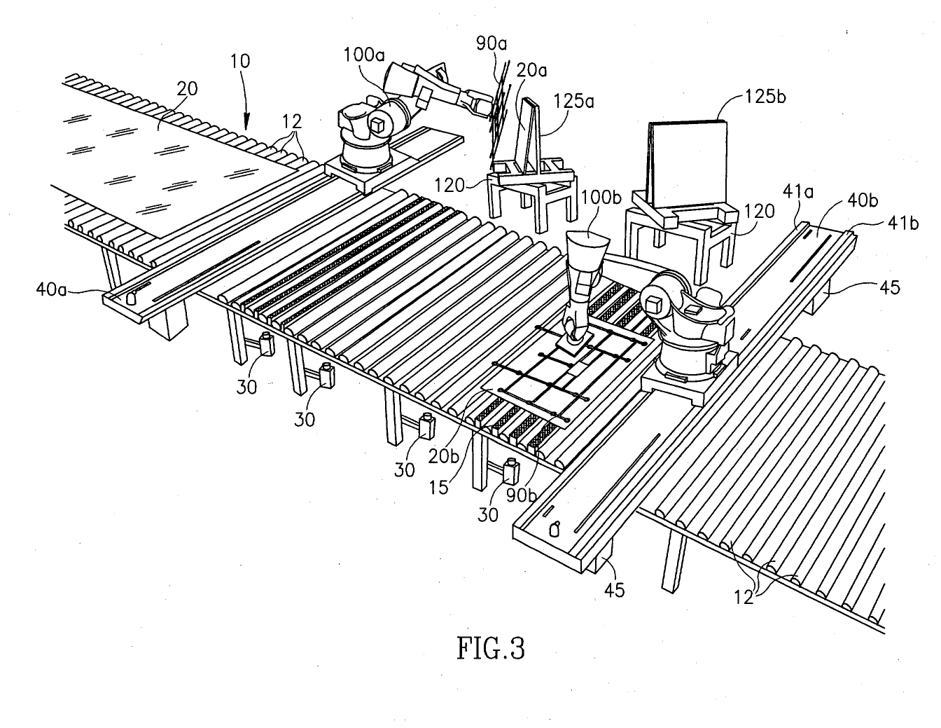

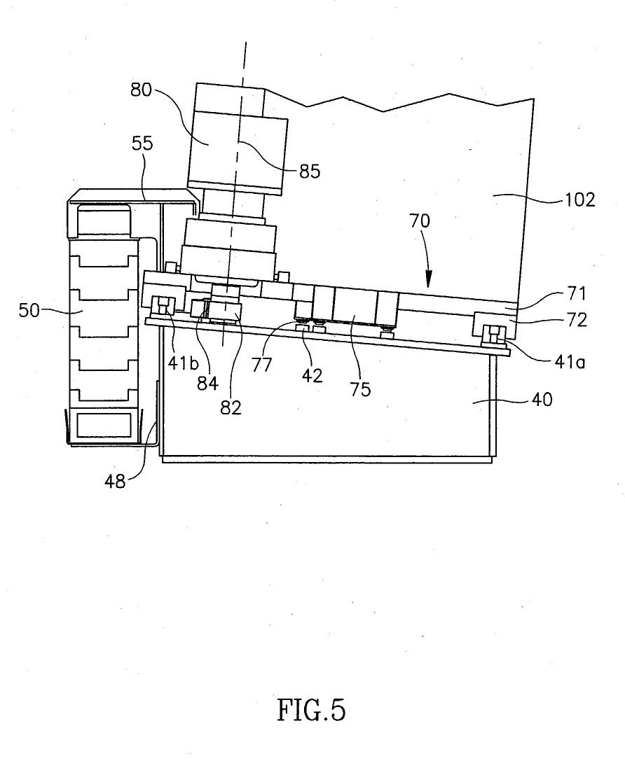

Referring now to the figures, FIGS. 1 and 3 depict in a perspective view the present robotic system operating in a synchronized mode and in an independent mode, respectively. For clarity sake, only glass racks positioned at one side of the conveyor are illustrated. However, it will be understood that glass racks are positioned on both sides of the conveyor. A conveyor 10 comprising rollers 12 is continuously conveying glass sheets 20, preferably jumbo-sized and/or LES and or split-size glass sheets, along the conveyor longitudinal axis, hereinafter referred to as the conveyor main axis. Two bridges 40 supported on legs 45 are extending parallel to each other, above and across conveyor 10 perpendicularly to the longitudinal axis of conveyor 10. According to the embodiment shown here, each of bridges 40 includes a pair of parallel linear guides 41a and 41b, extending along the inner and distal edges of bridge 40 respectively, on which a carriage 70 supporting robot 100, is movably mounted. Carriage 70 is provided with a driving mechanism for allowing traverse movement of the robot along bridge 40 and across conveyor 10. As shown in detail in FIG. 5, carriage 70 comprises a robot mounting plate 71 for supporting robot base 102 and four mounting members 72 disposed at the four comers of plate 71. Members 72 are slidably engaged with guides 41 by means of circulating linear bearings (not shown) provided within each of members 72 such that members 72 together with linear guiding rails 41 define a linear bearings system for providing smooth, low friction and highly accurate linear motion. According to the embodiment shown in FIG. 5, the driving mechanism for carriage 70 is a rack and pinion drive mechanism comprising a tooth wheel 82 mounted on central shaft 85 of geared motor 80, coupled to tooth rack 84 which extends along bridge 40, proximate its distal edge.

However, it will be easily realized that the invention is not limited to the driving mechanism and/or to the sliding means described here and that other driving mechanisms for allowing smooth linear movement of carriage 70 along bridge 40 are possible without departing from the scope of the invention. It will be also realized, that carriage 70 may be mounted not on the upper surface of bridge 40 but on rails extending along the inner side wall of the bridge. Carriage 70 is further provided with two end-detecting plates 75 vertically mounted on plate 71, facing opposite ends of bridge 40. Plate 75 includes sensors 77 located at the plate bottom, directed downwardly toward a set of rulers 42 stretching on the upper face of bridge 40, as is best seen in FIG. 1, 3 and 5. Rulers set 42 includes two long rulers 42a and 42b and two short rulers 42c deposited at opposite ends of the bridge. Long rulers 42a and 42b each extending from an opposite end of bridge 40 and ending at predetermined distances beyond and before the bridge center, respectively, define the location of carriage 70 with respect to the bridge center. Rulers 42c provide an indication when carriage 70 approaches a bridge end. Thus, upon detecting either one of short rulers 42c, an end-of-travel limit switch is activated for preventing further travel of carriage 70 toward the bridge end. As a further precautionary means, bridge 40 is provided with bumpers 46 located at a predetermined distance from the bridge end, for stopping carriage 70 in case of failure of end-detection plate 75.

Robots 100, mounted in an upright position on carriage 70, are identical heavy payload articulated industrial robots. Each of robots 100 includes a base 102 supported on carriage 70, an arm 104 rotatble relative to base 102, a wrist 106 and a programmable controller (not shown) for controlling the robot movements. Preferably robot 100 is a 6-axis robot of a wide arm reach and a wide work envelope, comprising in addition to the rotational axis about the base, two arm joints and a three-axis wrist, such as for example the Kawasaki ZX series. A gripper device 90, comprising a frame 95 and a plurality of vacuum suction cups 98, is connected via mechanical link to wrist 106 for grasping the glass sheets. The vacuum suction cups 98, coupled to a vacuum pump (not shown), are divided into multiple groups, which are activated automatically and independently according to the specific plate size and position, eliminating any need for manual setting. Vacuum cups 98 are supported on springs 99 for allowing gentle grasping of the glass, decreasing damage and scratches.

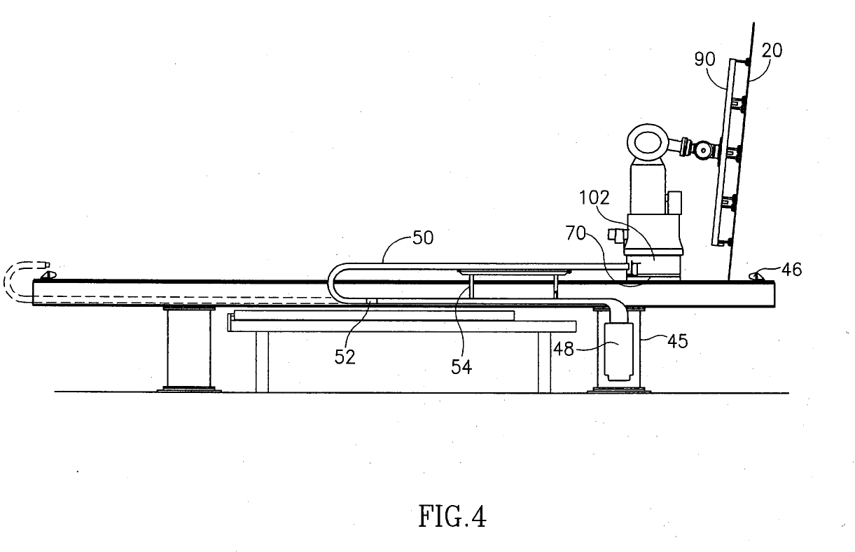

The wiring required for robot 100 operation, including power supplying cables and communication lines to the robot controller are reinforced to one of bridge 40 legs 45 from which they are bundled together and connected to robot base 102 by means of cable chain 50 (best seen in FIG. 4) which is supported by a generally U-shaped open channel 48 (best seen in FIG. 5) running along the external wall of bridge 40. One end of chain cable 50 is anchored to bridge 40 at about its middle point 52 while its other end is reinforced to robot base 102 by connector 55 for following the robot linear movement along bridge 40. A supporter 54 mounted on channel 48 supports chain cable 50 when the robot is in the right section of bridge 40 and cable 50 folds on itself as illustrated in FIG. 4. Also shown in FIG. 4, in phantom lines, is cable 50 when the robot is positioned on the left section of bridge 40.

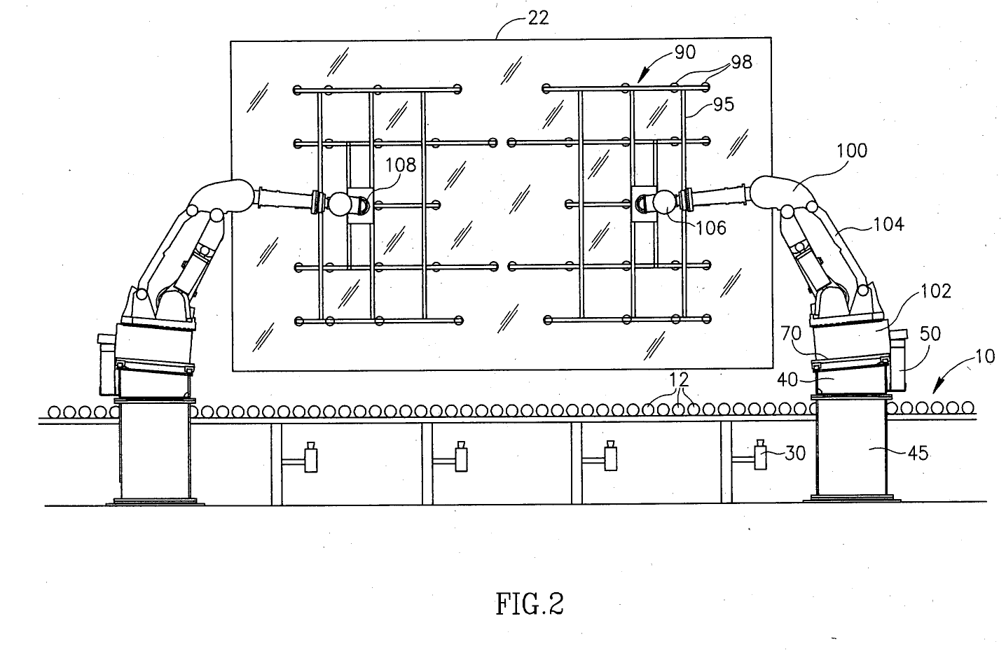

The distance between bridges 40 is sufficiently large to allow one jumbo plate, two LES plates or four split size plates to be positioned between bridges 40. The height of bridges 40 above conveyor 10 can be kept to the necessary minimum for allowing vertical clearance above the conveyor for the passage of the glass sheets. Preferably, the vertical clearance is of 25 to 500 mm. Thus, bridges 40 do not put any height constrains on the system. In order to increase the reach of robots 100 toward the area between and below bridges 40, the upper surface of bridges 40 are inclined toward the center such that outer rail 41b is positioned higher than inner rail 41a, as is best seen in FIGS. 2 and 5. Consequently, carriages 70 and robots 100 are having an inclination angle toward the central area between bridges 49. Preferably, the inclination angle does not exceed 200.

A series of sensors 30, located under conveyor 10 between bridges 40, detect the exact position of glass plates 20 along the main axis of conveyor 10. In the embodiment described in FIG. 1, conveyor 10 further includes two groups 14a and 14b of popup belts 15 for allowing a plate 20, when reaching the correct position between bridges 40, to be raised above conveyor 10. The lifted plate resting on belts 15 can then be handled without interfering with the continuous movement of conveyor 10. After the plate is removed, belts 15 are retracted to their lower position ready for the next plate. The two separate belt groups 14a and 14 can be operated either simultaneously or independently in accordance with the size of the arriving plates. Thus, for a jumbo size both groups should be operated simultaneously while for LES and split size plates, each group of belts can be operated independently for lifting up one LE or split size plate or two split size plates. Belts 15, may further allow for mechanical alignment of the plate in the direction perpendicular to conveyor 10 main axis. The alignment of the plate, also known in the art as squaring, is achieved by moving belts 15 along their longitudinal axis (i.e., perpendicularly to conveyor 10 main axis) for pushing the glass sheet against alignment stoppers (not shown), as known in the art. Yet the present invention may allow for the complete elimination of the squaring mechanism with the aid of additional sensors, as any offset in sheet positioning, can be calculated by the robot program to be compensated and corrected during the motion of grippers 90 such that the plates will be stacked precisely in spite of any such offset. The elimination of mechanical squaring offers the advantage of fewer mechanical elements and more importantly of preventing damage and abrasion that might be caused to the glass edge by the squaring stoppers. Furthermore, the elimination of squaring also allows for handling two split size plates resting on the same belt group 14.

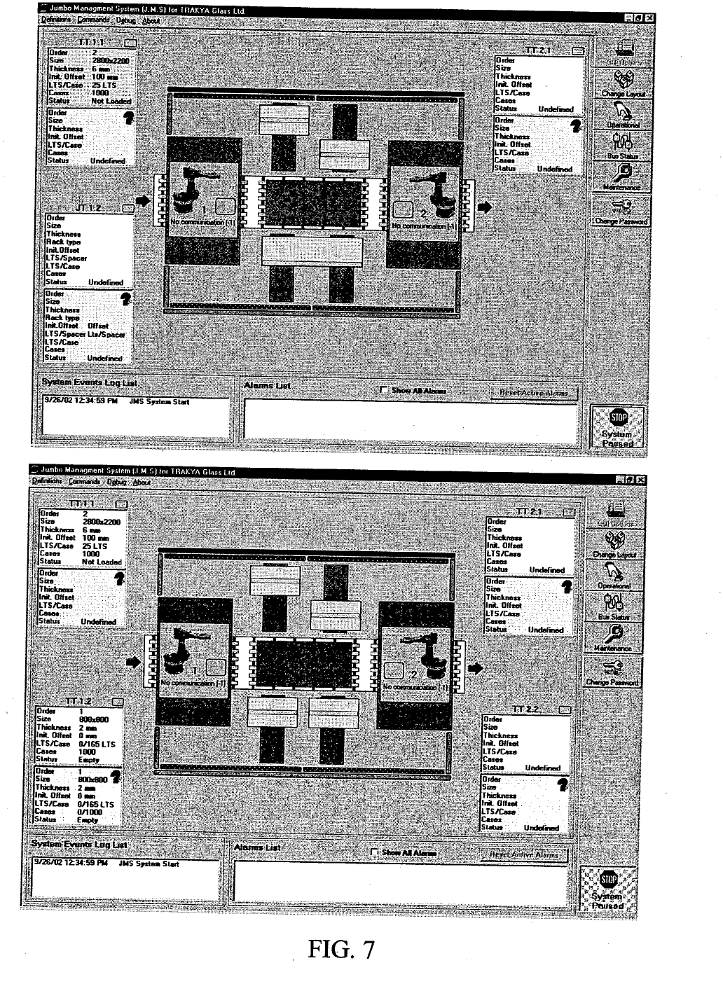

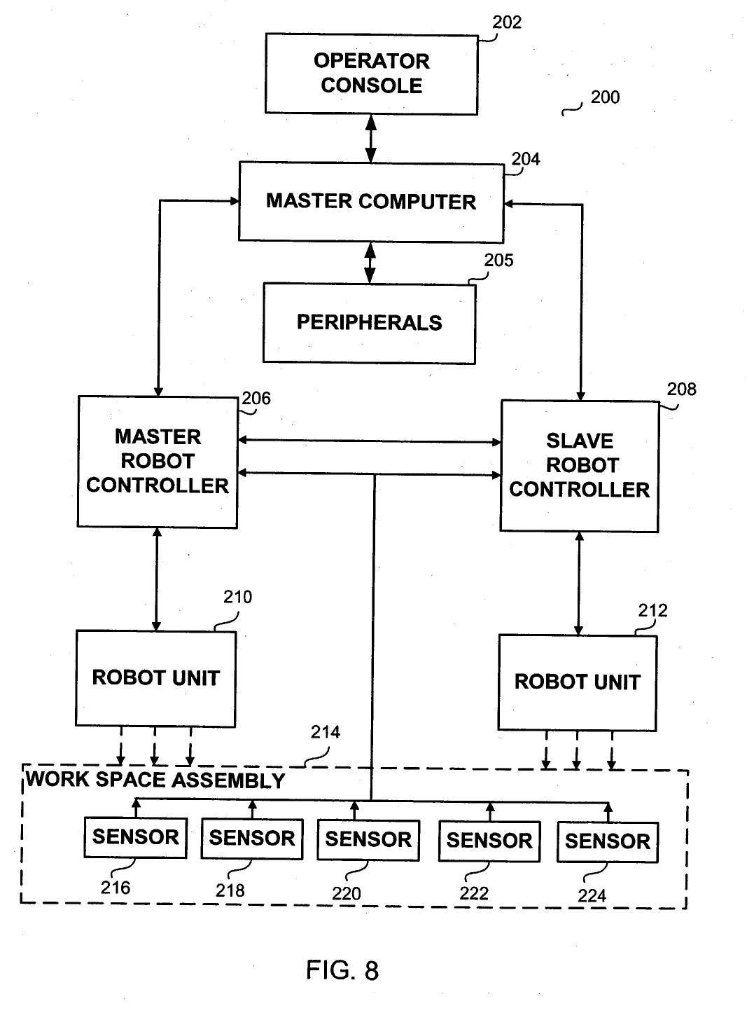

A master computer in communication with the controllers of robots 100 controls the robots operation. The master computer receives and analyzes information regarding customer order scheduling and determines which robot will handle which glass plate and when robots 100 should operate in full synchronization mode or in an independent mode. Accordingly, the master computer sends orders to robots 100 regarding incoming glass sheets and the desired rack for each sheet. The information regarding customer orders is preferably received in the master computer by direct connection to the production line mainframe computer. Alternatively, the information can be loaded locally to the master computer memory. The master computer further gathers data from sensors 30 and from any other monitoring or diagnostic system that might be installed along the production line. Such a monitoring system may be, for example, a camera system installed above the production line prior to the unloading stations, which overviews the cut glass and measures the precise size and orientation of each glass sheet. The master computer may further control the glass racks management for allowing automated stock administration. Preferably the master computer is provided with a monitor panel for allowing manual initialization and control of stacking procedures. FIG. 7 gives two exemplary screenshots of the monitor panel. A detailed description of the computerized robots control network and the robot control programs is given below in conjunction with FIG. 8-12.

During operation, each of the robot controllers receives from the master computer information regarding incoming glass sheet 20 to be handled by the robot, including the desired rack for the sheet staking. Accordingly, each of the robot controllers processes the information and calculates the -required trajectory of gripper 90 for performing the task. When a synchronized cooperation of the two robots is required for handling a jumbo-sized sheet, one robot is selected as a master robot and the other robot as a slave robot.

When robot 100 receives an order to pick up a particular glass sheet 20 and to stack sheet 20 on a specific rack, the robot first moves along its respective bridge 40, substantially to the center of the bridge to lift up glass sheet 20. At this point gripper 90 is in a horizontal position. When suction cups 98 are in contact with the glass sheet, vacuum is activated in selected groups of cups 98 in accordance with the sheet dimensions and orientation. When the vacuum reaches a predetermined level, the plate is lifted up and as the robot moves toward the stacking rack, plate 20 is gradually rotated to a substantially vertical position by corresponding controlled rotation of wrist 106, to be placed on the desired rack.

FIG. 1 shows robots 100 in a synchronized operation mode, unloading a jumbo plate 22 onto jumbo rack 110. As mentioned above, during synchronized cooperation, one of the robots is selected as a master robot. The second robot, being the slave robot, follows the movements of the master robot such that the movement of the slave robot are mirror image of the movements of the master robot. Full synchronization between robots 100 starts when both grippers 90 are in contact with jumbo glass sheet 22 and ends only after the glass sheet is already placed on the rack and the vacuum in vacuum cups 98 of both grippers 90 is released. However, when grippers 90 are not engaged with a glass sheet, as is the case when robots 100 move to the center of the bridge for handling the next jumbo sheet, each robot may move independently, i.e. the master-slave relationship which slows down the robots can be turned off until both grippers 90 are engaged with the next sheet.

FIG. 3 shows robots 100 during independent operation mode while handling two LES sheets. As can be seen, in an independent operation mode, each of robots 100 moves independently on its corresponding bridge to lift a plate and to move in a manner for placing the plate on the desired rack. Thus, while robot 100a is shown to be located at the far end of its corresponding bridge 40a with gripper 90a at a substantially vertical orientation for placing plate 20a on rack 125a, robot 100b is located at the middle of its corresponding bridge 40b inclining toward conveyor 10 with gripper 90b at a substantially horizontal position for picking plate 20b. During LES stacking, LES racks 125a and 125b are preferably placed in an angle to the main conveyor axis for facilitating rotation of a sheet in the sheet plane as well as from horizontal to vertical orientation in order to place the LES plates in a landscape orientation. In the configuration shown in FIG. 3, the two LES racks 125a and 125b are positioned on the same side of conveyor 10. However, it is easily realized that since the reach of robots 100 is equivalent to both sides of the conveyor, four different LES or split size racks can be positioned, two on each side of the conveyor, such that four types of LES and/or split size sheets of different sizes and/or qualities can be unladed onto the racks. It will be also realized that in the case of split-size glass, where two split-size plates may arrive simultaneously to the same belt group 14, the robot close to this specific belt group handles the two plates. The robot may pick one plate to place it on the appropriate rack, then translates along the bridge to pick up the second plate. Alternatively, the robot may lift up the two plates simultaneously to place them one after the other either on the same rack or on two different racks positioned on opposite sides of the conveyor, where between the two operations gripper 90 is rotated appropriately.

The present system has three basic configurations for unloading a production mix of Jumbo, LES and split-size plates:

a) two Jumbo unloading stations, one on each side of the conveyor line;

b) one Jumbo unloading station on one side of the conveyor and two LES or split-size unloading stations on the other side;

c) four LES or split-size unloading stations, two on each side of the conveyor.

The LES unloading stations can be used for landscape or portrait stacking. The system is also capable of unloading LES plates on a Jumbo rack in a portrait orientation or split size plates on a LES or jumbo racks.

The unloading stations are platforms or rotating tables used for placing glass racks in an elevated position. A wide variety of racks, including L-type and A-type racks can be placed on the platforms according to customers orders.

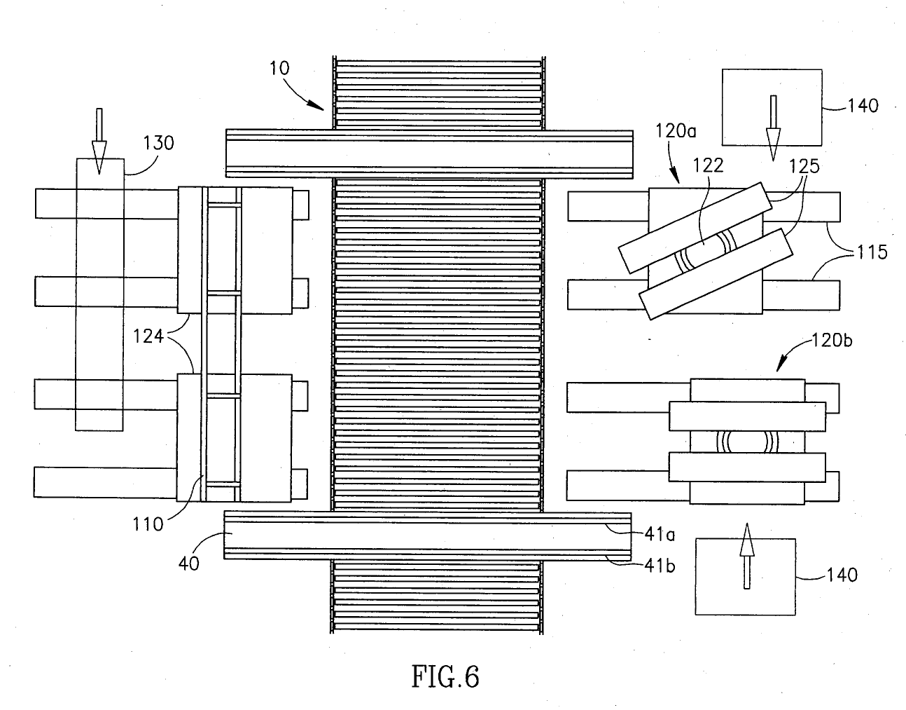

FIG. 6 is a schematic top view of the present system in accordance with configuration (b). In accordance with this configuration, one jumbo rack 110 is positioned on the left side of conveyor 10 and two LES racks 125 are positioned on the right side of conveyor 10. Jumbo rack 110 is placed on two jumbo platforms 124 parallel to the main conveyor axis. The two LES racks 125, preferably A-type racks, are placed each on a rotating table 120. Four pairs of rails 115 orthogonal to the main conveyor axis are provided at the floor level for allowing jumbo platforms 124 and rotating tables 120 to travel between a first position proximate to conveyor 10 for stacking glass sheets onto the racks and a second distal position for loading empty racks onto the tables or for removing filled racks. Also shown in FIG. 6 are fork-lifts 140 for loading/removing LES racks 125 and fork truck 130 for loading/removing jumbo rack 110. Rotating tables 120 are provided with a rotating plate 122 which allows the rotation of racks 125 such that when one side is filled, plate 122 is turned by 180 degrees for allowing filling the other side. Plate 122 may rotate automatically as the racks are filled allowing the robots to continue the unloading without waiting for the removal of the filled rack. Rotating table 120 also allows for positioning racks 125 in an angle to the main conveyor axis for facilitating the stacking of LES sheets on their wider side as mentioned above. While the Jumbo rack is parallel to the main line and the LES is placed in an angle. Special sensors are used in the system, in order to define the rack position and orientation. Once the rack position is detected and known, the robots are calculating the next plate target position using the plate thickness parameter. This capability eliminates the need for heavy mechanical indexing platforms and civil woks. The pack edge alignment is achieved by using an optical sensor for detecting the exact edge position.

The proposed system and method reduces capital investment by providing flexible handling of a variety of mixed sizes and qualities of glass plates. Due to its novel configuration, the system occupies a much smaller floor space than known stackers and reduces height requirement as well. The gentle gripping method and precision stacking capabilities improve quality by ensuring fewer breakages and scratches caused during handling.

Although the above description refers mostly to unloading glass plates from a conveyor onto racks, it will be easily realized by persons skilled in the art that the present system can be used for the reverse operation, i.e., for transferring plates from a rack to the conveyor for applications where the plates packed at one location are going further processing at another location. It will be also realized that the present system may be used for repacking, i.e., for transferring glass plates from one rack to another.

Referring now to FIG. 8 the robot control network 200 includes a system operator console 202, a master computer 204, a master robot controller 206, a slave robot controller 208, robot units 210 and 212, a work space assembly 214, and a set of sensor devices 216, 218, 220, 222 and 224. Master computer 204 is a computing platform such as a desktop personal computer. Alternatively, other computing devices having a central processing device, a memory device, and human and communications interfacing devices can be used. Computer 204 is connected typically via a local area network (LAN) or a wide area network (WAN) using an Ethernet or like communications device to master robot controller 206 and slave robot controller 208. Computer 204 is connected typically via an open field bus system, such as the INTERBUS to the system's peripheral devices 205 such as the turntables and carriages motor drives. Master computer 204 is operative in the overall control of the robot stacking system. Computer 204 stores a dynamic work plan that defines in a suitable manner the configuration, the mode, the timing, and the manner concerning the operations of the robot controllers 206, 208. Computer 204 is further used as the robot stacking system interface with the operator via the operator console 202.

A system operator console 202 is connected to the master computer 204 via the master computer serial communication port and is used as an I/O device interfacing the master computer 204 and the operator. The system operator console 202 is typically operated by a human operator though the system can operate automatically without human intervention. The console 202 receives messages indicative of the status of the robot controller network, such as the operative status of the robotic controllers 206, 208. The console 202 may provide indications to the human operator concerning received messages via a suitable user interface. The console 202 is further operative in accepting input commands from the human operator in order to make available the option of externally controlling the operation of the robotic stacking systems. Thus, the human, operator could override the work plan previously transmitted to the master robot by introducing diverse differing parameters.

Master robot controller 206 controls the operation of robot unit 210. Controller 206 controls robot unit 210 by sending appropriate motion commands to the motors of robot unit 210. The motion commands sent to the motors of robot unit 210 are based on the instructions embedded in the robot control program in conjunction with the control data stored within computer-readable files on the master robot controller 206. Master robot controller 208 controls robot unit 212. Controller 208 controls robot unit 212 by sending appropriate motion commands to the motors of robot unit 212. The motion commands sent to the robot unit 212 are based on the instructions embedded in the robot control program and on the control data stored within computer-readable files on master robot controller 206. As described herein above the robot units 210 and 212 are operative in the suitable handling of the products introduced automatically to the workspace assembly 214. The workspace assembly 214 is an automatic conveyor device that includes a set of sensor devices 216, 218, 220, 222, and 224. Sensor devices 216, 218, 220, 222, and 224 are distributed in a well-defined manner within the workspace assembly by collecting data concerning the characteristics of the handled products. The data collected by the sensor devices 216, 218, 220, 222, 224 is transmitted to the robot controllers 206, 208. The sensor data is suitably pre-processed and sent to the robot control program. The information is analyzed in order to provide the program with size parameters, location parameters, and the like s. For example, the sensor-based information could be used to identify the type of product introduced into the conveyor. In accordance with the identified type of product, various operational configurations could be defined, different operation modes could be activated and different program modules could be loaded and executed.

In the preferred embodiment of the invention the robot control system operates in two distinct operational modes. In the first operational mode, either master robot controller 206 or slave robot controller 208 operates independently of each other. In such a case, one of the controllers 206, 208 operates, while the other controller remains immobile. In the second operational mode, the master robot controller 206 and slave robot controller 208 operate together synchronously and cooperatively. In the second operational mode, master robot controller 206 controls the operation of the slave robot controller 208. Master robot controller 206 executes a master module of the robot control program that provides for suitable manipulation of robot unit 210 linked to the master robot controller 206. In addition, the master module of the robot control program executed by master robot controller 206 is operative in establishing communication with the slave robot controller 208 via a communication line. The communication is provided in order to enable for synchronized operation of the master controller 206 and the slave controller 208. The slave robot controller 208 executes a slave mode module of the robot control program. The slave mode module receives motion information from the master module, transforms the information in a pre-defined manner and controls the robot unit 212 accordingly. A more detailed description of the cooperative operation between the master robot controller 206 and the slave robot controller 208 will be provided herein after in association with the following drawings.

Although on the drawing under discussion only a limited number of robot controllers and robot units are shown it is conceivable that in other embodiments of the invention one or more robot controllers could be used to control one or more groups of robot units. The robot controllers could operate either independently or cooperatively with a master robot controller controlling one or more slave robot controllers in order to achieve synchronous operation between the controlled robot units.

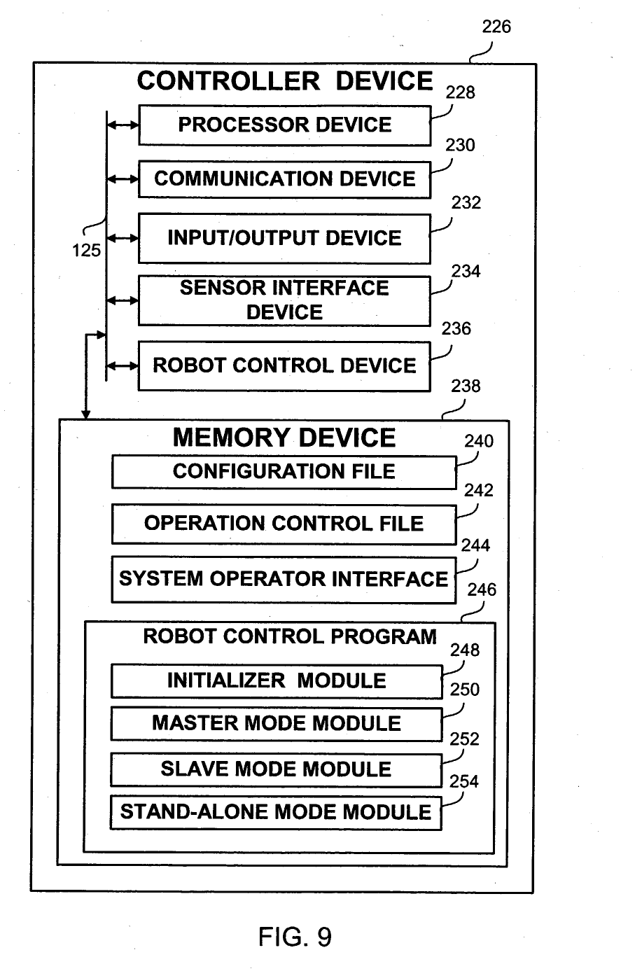

Referring now to FIG. 9 robot controller 226 is operative in controlling an associated robot unit, in controlling another robot controller in order to accomplish for cooperative operation of robot units, and in being controlled by another robot controller in order to accomplish cooperative operation of robot units. Controller 226 includes a processor device 228, a communication device 230, an input/output device 232, a sensor interface device 234, a robot control device 236, and a memory device 238. The processor device 228 generally controls the operation of the robot controller 226. Communication device 230 provides communication capability to the controller 226 where the communication is performed via a communication network. In the preferred embodiment of the invention, the network is a wired LAN network. In other embodiments other networks could be used, such as a wireless LAN, and the like. Communication device 230 is typically a network interface card (NIC). Input/output device 232 provides the option of interfacing with the users of the system either by displaying audio or video indications or by receiving user commands regarding troubleshooting, maintenance, administration, and the like. Sensor interface device 234 is operative in receiving and processing sensor data, such as converting analog signals to digital, and the like. The sensor data is useful in determining the characteristics of the workspace, product size data, product location data regarding the product introduced into the workspace. Robot control device 236 generates robot unit axis control commands that are fed to robot units through servo amplifiers. Memory device 238 stores the robot control program and the associated control files. Memory device 238 could be a hard disk, a RAM, a ROM, a nonvolatile memory or any combination thereof. Device 238 includes a configuration file 240, an operation control file 242, a system operator interface 244, and a robot control program 246. Configuration file 240 defines the network configuration, such as the number of robot controllers, the identification of the robot controllers, the task assigned for each robot controller, and the like. Operation control file 242 describes the general work plan of the operation. File 242 could include product batch sizes, product types within a batch, operations associated with a specific batch, operational modes associated with a specific batch, and the like. Control file 242 could further include definitions, such as status value descriptions, error codes, and the like. Robot control program 246 includes an initialization module 248, a master mode module 250, a slave mode module 252, and a stand-alone mode module 254. Initialization module 248 is responsible for the setting up of the program, such as loading the operation control data, and-the like. Master mode module 250 provides the logic for the operation of master robot controller where synchronous cooperative operation is needed. Slave mode module 252 includes the program logic for the operation of slave robot controller where synchronous cooperative operation is required. Stand-alone mode module 254 is executed where a robot controller operates independently without controlling another robot controller or without being controlled by another robot controller.

In the preferred embodiment of the invention only one robot controllers is defined in such a manner as to have the functionality of operating in stand-alone mode. In other embodiments either the master robot controller or the slave robot controller could operate in stand-alone mode. In the preferred embodiment of the invention the synchronous cooperative operation is designed such that master robot controller executes the master mode module, and slave robot controller executes the slave mode module. Thus, master robot controller controls the operation of the slave robot controller. In other embodiments of the invention both robot controllers could be assigned to be either a master robot controller or a slave robot controller.

Note should be taken that the above-described structure and constituent elements of the controller 226 are exemplary only. Following the reduction to practice of the invention, additional devices, interfaces, and program modules could be added, some elements could be dropped, and some elements could be combined.

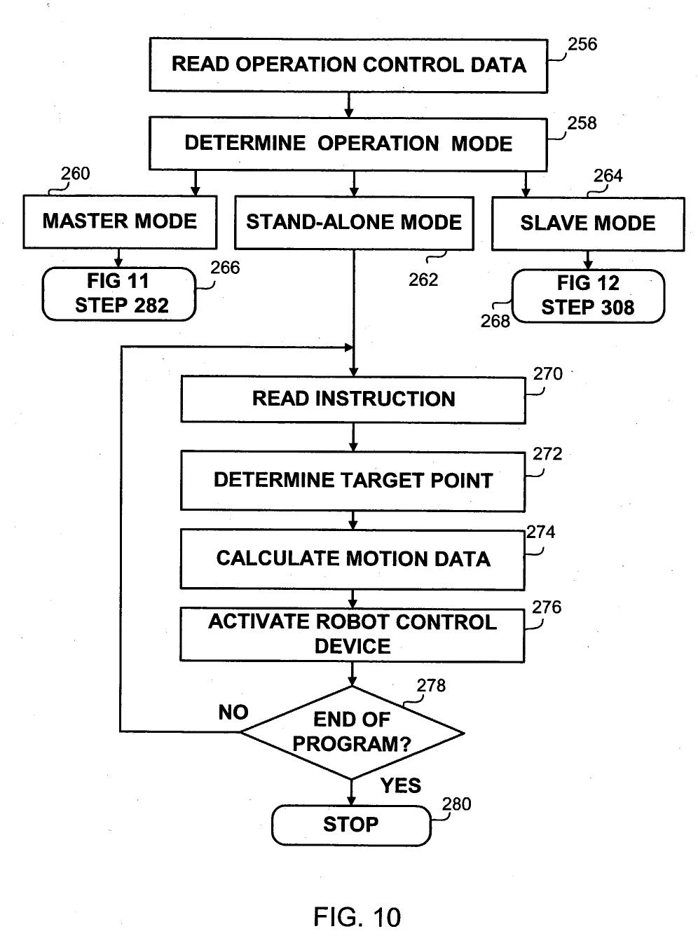

Referring now to FIG. 10 that describes an exemplary program flow operative in the initialization of the program and the execution of the stand-alone mode module. The robot control program is loaded from the memory device of the robot controller and begins to execute. At step 256 the operation control data is read from the memory device of the robot controller. The operation control data includes a temporary value indicative of the required mode of operation. Thus, at sep 258 it is determined whether the required operational mode is the master mode 260, the stand-alone mode 262 or the slave mode 264. When it is determined that the required operational mode is the master mode 260 then program control proceeds to step 266 for the loading of the master mode module and the subsequent execution of the master mode module. The suitable operation will be described herein under in association with the following drawings. When it is determined that the required operational, mode is the slave mode 264 then program control proceeds to step 268 for the loading of the slave mode module and the subsequent execution of the slave mode module. The suitable operation will be described herein under in association with the following drawings.

Still referring to FIG. 10 if it is determined that the required operational mode is the stand-alone mode 262 than at step 270 an program instruction is fetched and executed by the processor. The instruction typically concerns the manipulation of an associated robot unit, such as moving the end-effector of the robot unit from a specific spatial location to a different location. According to the instruction at step 272 the targeted point in space is determined in a manner known in the art. At step 274 the appropriate motion data is calculated and at step 276 the robot control device is activated in order to transmit motion commands to the robot unit. The motion command could regard one or more robot axes operative in the spatio-temporal re-location of the robot unit's end-effector. The motion command could further involve acceleration/deceleration parameters. At step 278 it is determined whether there are more instructions to be fetched from the control program. If the control program includes additional then program control proceeds to step 270 to read the next program instruction. The program loop across steps 270 through step 278 is executed until all the instructions in the program were obtained and processed. After the last instruction in the program was processed, the program is stopped at step 280.

Note should be taken that the above-described operation is performed by a robot controller independently of other available robot controllers. This kind of operation is typically performed when the relevant characteristics, such as shape, size and weight, of the product to be handled allow for the operation of a single robotic unit. Thus, in the preferred embodiment of the invention, in order to move a LES-type or a split-size plate into the specific stacking place a single robot unit is sufficient.

The above-described operation is exemplary only. For the easy understanding of the invention the description was provided in a substantially simplified manner. For example, the motion trajectory and motion duration of a realistic robotic arm and the associated end-effector between spatio-temporal locations is typically divided into interpolation points and motion data calculation, acceleration/deceleration processing, and the like, is performed at each interpolation point.

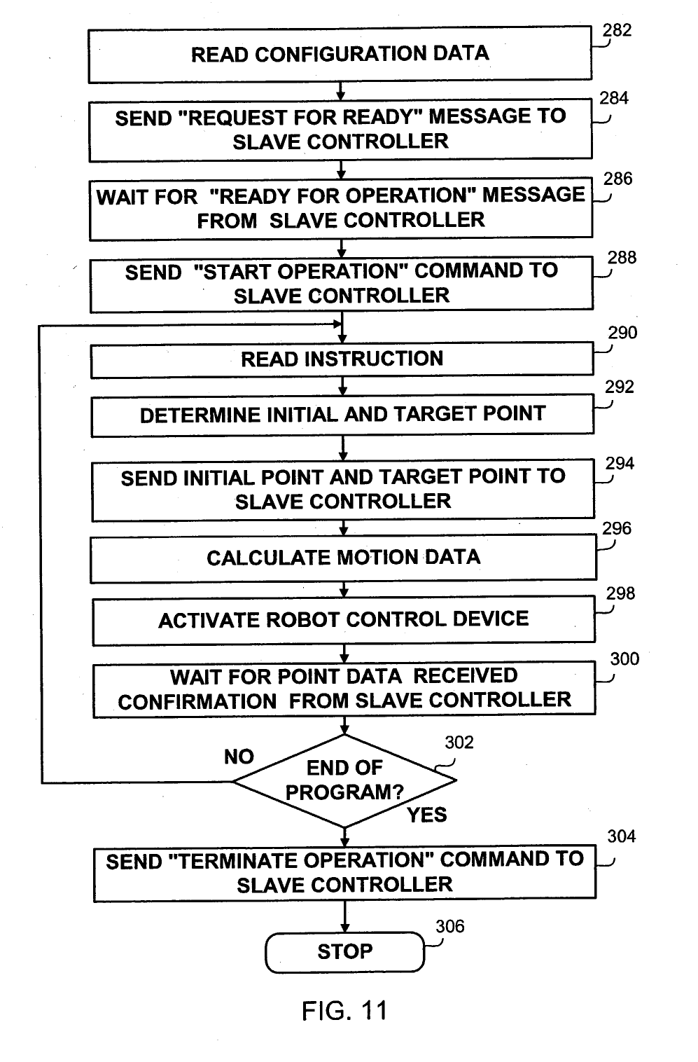

Referring now to FIG. 11 that describes an exemplary program flow operative in the execution of the master mode module. The synchronously cooperative mode of operation is utilized when the characteristics of the product to be handled are such that a single robot unit is not sufficient for secure handling. Thus, handling large-sized, heavy products necessitates cooperative performance of both robotic units. In the synchronously cooperative mode of operation the master mode module is executed by the master robot controller. At step 282 the configuration data is obtained in order to determine the functional relationships of the robot controllers within the network. Thus, for example, at step 282 the controller running the master mode module determines the identity of the slave robot controller to be controlled. At step 284 a message requesting “ready for operation” notification from the slave robot controller is sent by the master mode module to the identified slave robot controller. At step 286 the master mode module enters a wait state until a “ready for operation” response is received from the slave robot controller. When the suitable response is received at step 288 a “start operation” command is sent to the slave robot controller. Then, at step 290 a program instruction is fetched from the master mode module and executed by the processor device. The instruction includes one or more commands operative in the determination of the initial point location and the target point location of the robotic arm (step 294). In order for synchronized cooperative operation between the master robot controller executing the master mode module and the slave robot controller executing the slave mode module, at step 294 point location information is sent to the slave robot controller. At step 296 motion data is calculated and at step 298 the robot control device is activated to accomplish the requested robot arm movement. At step 300 the master mode module enters a wait state until confirmation is received from the slave robot controller concerning the reception of the point location data sent at step 294. At step 302 it is determined whether the master mode module includes additional program instructions. If additional instructions exist then program control proceeds to step 290 to fetch the next program instruction. For each program instruction the program executes a program loop across steps 290 through step 302. Each of the program instructions, which typically include motion commands, are executed, and the calculated motion data is sent to the slave robot controller in order to provide for synchronized operations between the master robot controller and the slave robot controller. If at step 302 it is determined that all the program instructions were processed then at step 304 a “terminate operation” command is sent to the slave robot controller and at step 306 the execution of the master mode module terminates.

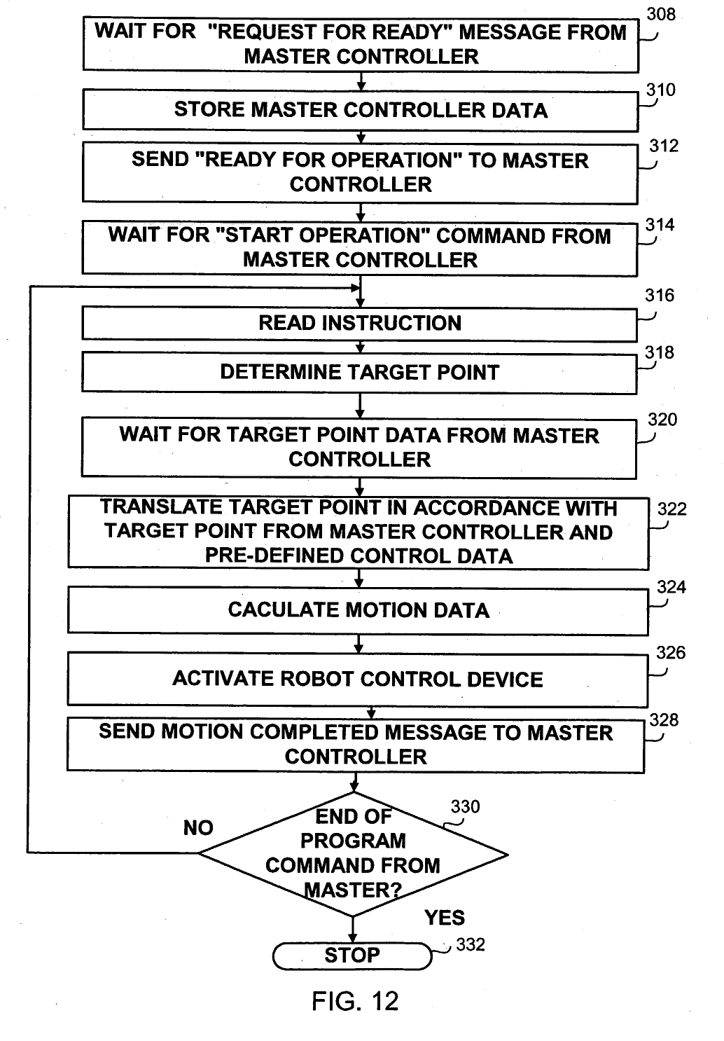

Referring now to FIG. 12 that describes an exemplary program flow operative in the execution of the slave mode module. In the synchronously cooperative mode of operation the slave mode module is executed by the slave robot controller. At step 308 the slave mode module waits for a “ready for operation” message request from the master robot controller. When the message is obtained at step 310 the master robot controller data embedded in the message is stored for future reference. At t step 312 in response to the request message the slave mode module sends a “ready for operation” reply message to the master robot controller. At step 314 the slave mode module enters a wait state until the “start operation” command is received from the master robot controller. In response to the command, at step 316 a program instruction is fetched from the slave mode module and executed by the processor device. The instruction includes one or more commands operative in the determination of the target point location of the robotic arm of the robot unit associated with the slave robot controller (step 318). At step 320 the slave mode module waits for target point location data from the master robot controller. When data is received at step 322 the target point data is transformed in accordance with the target point data received from the master robot controller, and in accordance with a pre-defined spatial coordinates transformation table. Consequently, at step 324 motion data is calculated and at step 326 the robot control device of the slave robot controller is activated in order to generate suitable motion commands to the robot unit associated with the slave robot controller. At step 328 a message concerning the completion of the motion is sent to the master robot controller. At step 330 it is determined whether a “program termination” command was received from the master robot controller. If no termination command was received then program control proceeds to step 316 to fetch the next program instruction of the slave mode module. Subsequently, for each fetched program instruction, the slave mode module executes a loop across step 316 through step 330. Each instruction typically includes one or more commands operative in the generation of motion commands to the robotic arm of the robot unit. If at step 330 it is determined that a “terminate operation” message was received from the master robot controller then at step 332 the operation of the slave mode module terminates.

Note should be taken that while the above-described operation is performed for each product to be handled the overall robotic stacking system requires substantially continuous operations. Thus, following the completion of the handling of a specific product and the termination of the stand-alone module or the master mode module/slave mode module, program controls proceeds to step 256 of FIG. 1 in order to perform preparations and consequent processing operative in controlling the robot units for the handling of the next product introduced into the workspace.

The execution of the master mode module in the master robot controller and the execution of the slave mode module in the slave robot controller provide for a synchronous cooperative operation of the master robot controller and the salve robot controller. Thus, the robot unit controlled by the master robot controller and the robot unit controlled by the slave robot controller operate in a suitably cooperative manner in order to accomplish a pre-defined task.

It will be appreciated by persons skilled in the art that the present invention is not limited to what has been particularly shown and described hereinabove. Rather the scope of the present invention is defined only by the claims, which follow.

1. A robotic system for transposing glass sheets of mixed sizes from a conveyor onto unloading platforms and vice versa, the conveyor having a longitudinal axis along which the glass sheets are moving in a substantially horizontal orientation, the system comprising:
two parallel bridges extending at a predetermined height above and across the conveyor perpendicularly to the conveyor longitudinal axis, the two bridges are spaced apart by a predetermined distance defining a conveyor working surface area there between;
a pair of programmed-controlled articulated industrial robots movably mounted in an upright position each on one of said two bridges for allowing linear movement of the robot along respective bridge, each robot includes an arm, a wrist, a gripping device connected to the wrist and a controller for controlling the movements of the robot; and
a master computer in communication with the robots controllers, the master computer controls the operation of the pair of robots for allowing a synchronized mode of operation for handling glass sheets to heavy and/or too big to be handled by one robot or an individual operation mode where each robot independently handles a single sheet.

2. The system of claim 1 wherein the unloading platforms are positioned on both sides of the conveyor.

3. The system of claim 1 wherein the unloading platforms include racks for stacking the glass sheets in a substantially vertical position.

4. The system of claim 1 further provided with a stopping mechanism for stopping and positioning at least one glass sheet in said conveyor working surface area.

5. The system of claim 1 wherein the glass sheets include jumbo-sized glass sheets.

6. The system of claim 5 wherein the glass sheets further include LES and/or split size sheets.

7. The system of claim 1 wherein the robots are six-axis heavy payload industrial articulated robots.

8. The system of claim 1 wherein the predetermined height of the bridges above the conveyor allows for a vertical clearance of 25 to 500 mm above the conveyor.

9. The system of claim 1 wherein each of the robots is mounted on a driven carriage provided with a driving unit for allowing linear movement of the robot along each respective bridge.

10. The system of claim 8 wherein the carriage is movably mounted on a linear guiding rail.

11. The system of claim 1 wherein the robots are mounted on respective bridges in an inclined angle for increasing the reach of the robot toward the conveyor working surface area.

12. The system of claim 1 wherein said unloading stations include one jumbo rack or two LES or split size racks positioned on each side of the conveyor.

13. The system of claim 12 wherein said jumbo rack is positioned parallel to the longitudinal axis of the conveyor.

14. The system of claim 12 wherein said LES or split size rack are positioned in an angle to the longitudinal axis of the conveyor.

15. The system of claim 1 wherein the gripping device is a vacuum gripper including a base frame and a plurality of suction cups supported on said base frame.

16. The system of claim 15 wherein the plurality of suction cups are divided into multiple groups and wherein each groups is controlled separately.

17. The system of claim 1 wherein when in a synchronized operation mode, one of the two robots is selected to be master robot and the other is selected to be a slave robot.

18. The system of claim 1 further comprising sensors for measuring the position of a glass sheet and for sending signals regarding said position to the robot controllers.

19. A method for unloading glass sheets of mixed sizes off a conveyor and for stacking the glass sheets onto unloading platforms positioned on both sides of the conveyor and for the reverse operation, the method comprising
installing two parallel bridges across the conveyor at a predetermined distance from each other, defining a conveyor working surface area therebetween;
providing a pair of programmed-controlled industrial articulated robots movably mounted in an upright position each on one of said two bridges for allowing linear movement of each robot along respective bridge, each robot includes an arm, a wrist, a gripping device connected to the wrist and a controller for controlling the movements of the robot; and
providing a master computer in communication with the robots controllers, the master computer controls the operation of the pair of robots for allowing a synchronized mode of operation for handling sheets too heavy and/or too big to be handled by one robot, or an individual operation mode where each robot independently handles a single sheet.

20. The method of claim 19 wherein the glass sheets include jumbo-sized glass sheets.

21. The method of claim 20 wherein the glass sheets further include LES glass sheets or split size sheets.

22. The method of claim 19 wherein the robots are six-axis heavy payload industrial articulated robots.

23. The method of claim 19 wherein the robots are mounted in an inclined angle for increasing the reach of the robot toward said conveyor working surface area.

24. The method of claim 19 wherein when in a synchronized operation mode, one of the two robots is selected to be master robot and the other is selected to be slave robot.

25. The method of claim 19 further comprising providing sensors for determining- the location of a glass plate on the conveyor working surface area.

26. A method for unloading glass sheets of mixed sizes off a conveyor onto unloading platforms positioned on either side or both sides of the conveyor in a system comprising at least two bridges extending above and across the conveyor and at least two program-controlled articulated robots movably mounted in an upright position each on one of said at least two bridges, each of the robots is provided with a gripping device, the method comprising the steps of:
receiving information regarding dimensions and designated unloading platform of an incoming glass sheets;
determining in accordance with said information whether a synchronized operation mode or an independent operation mode is required for handling an incoming glass sheet;
stopping at least one incoming glass sheet between said two bridges;
in an independent operation mode:
moving each of the robots independently along respective bridge to lift at least one glass sheet off the conveyor by the gripping device and to place the at least one glass sheet onto designated unloading platform; and
releasing the at least one glass sheet from the gripping device;
in synchronized operation mode:
moving the at least two robots each along respective bridge to substantially the center of the bridge;
moving the gripping device of each of said at least two robots to be in contact with the glass sheet;
synchronously activating the gripping devices to grip the glass sheet;
synchronously moving the robots and the gripping devices to lift the glass sheet off the conveyor and to place the glass sheet onto designated unloading platform; and
synchronously releasing the glass sheet from the gripping devices.

27. The method of claim 26 wherein in a synchronized operation mode, one of the two robots is selected to be master robot and the other is selected to be a slave robot.

28. The method of claim 26 further comprising the step of aligning the glass sheet to a position suitable for unloading.
